(19) United States
(12) Patent Application Publication
(10) Pub. No.: US 2018/0033082 A1
(43) Pub. Date: Feb. 1, 2018

(54) System and Method for Automatically Crossing Platforms to Perform Shareholder Voting

(71) Applicant: Taiwan Depository & Clearing Corporation, Taipei City (TW)

(72) Inventor: Ching-Li Meng, Taipei City (TW)

(21) Appl. No.: 15/658,410

(22) Filed: Jul. 25, 2017

(30) Foreign Application Priority Data
Jul. 29, 2016 (TW) 105124258

(51) Int. Cl. G06Q 40/04; H04W 12/06; H04L 29/06

(52) U.S. Cl. CPC G06Q 40/04; H04L 63/083; H04W 12/06; G06Q 2230/00

(57) ABSTRACT

A system and method for automatically crossing platforms to perform shareholder voting, wherein a user's authentication information is acquired via a first platform to allow the user to perform stock transactions with a first brokerage firm, wherein a command of the first platform allows the mobile device of the user to a second platform on the mobile device, wherein the second server obtains identifying information of the authentication information of the user to identify the user and communicates with the second platform on the mobile device to enable the user to perform a first shareholder voting through the second platform based on the total number of the first stock of the user.

### CROSS-REFERENCES TO RELATED APPLICATIONS

This patent application claims priority of Taiwan Patent Application No. 105124258, filed on Jul. 29, 2016, the entirety of which is incorporated herein by reference.

### BACKGROUND OF THE INVENTION

### I. Field of the Invention

The present invention relates to a voting system and a method thereof, and in particular, to an electronic voting platform to carry out a method of shareholder voting.

### II. Description of the Prior Art

Recently, the development of Internet applications has become more and more diverse with rapid advances. Some impossible things of the past have been gradually realized with the help of Internet applications. In the conventional voting systems, there is a variety of voting mechanisms, and shareholder meetings will consume a lot of times for a shareholder who owns a variety of different stocks, which will reduce the willingness of the shareholder to vote. In addition, shareholder voting for each stock is carried out independently and a paper notice is used for each share meeting, which not only increase the total cost for holding the shareholder meetings but also makes shareholders less willing to vote.

Accordingly, it is necessary to have a better solution to resolve the above-mentioned issues.

### SUMMARY OF THE INVENTION

One object of the present invention is to provide a system to carry out a method of voting by a shareholder so that the shareholder can use a broker's trading platform to link to a shareholder voting platform for shareholder to vote, wherein shareholder voting platform is associated with a total number of a stock of the shareholder obtained from different sources so that the shareholder can vote based on the total number of the stocks, thereby reducing the total cost and increasing the efficiency of the shareholder voting.

In one embodiment, the present invention discloses a method to carry out a shareholder voting by automatically crossing different platforms, the method comprising: using a first platform on a mobile device of a user to connect with a first server, wherein the first server communicates with the first platform on the mobile device and obtains the authentication information of the user associated with a first brokerage account of a first brokerage firm to enable the user to perform stock transactions with the first brokerage firm; using a command of the first platform on the mobile device of the user to connect the mobile device of the user to a second platform on the mobile device of the user; and using a second server to communicate with the second platform on the mobile device of the user, wherein the second server is associated with a total number of a first stock of the user obtained from different sources, wherein the second server obtains identifying information of the authentication information of the user to identify the user and communicates with the second platform on the mobile device to enable the user to perform a shareholder voting through the second platform based on the total number of the first stock of the user.

In one embodiment, the different sources includes all of the sources to obtain the first stock of the user, wherein the different sources comprise a plurality of brokerage accounts and an issuance company of the first stock.

In one embodiment, the first platform is provided by the first brokerage firm, and the mobile device of the user accesses the first platform through a first application.

In one embodiment, the first platform is provided by the first brokerage firm, and the mobile device of the user accesses the first platform through a first webpage.

In one embodiment, the second platform is provided by a financial institution managing the transaction information of the plurality of brokerage firms, and the mobile device of the user accesses the second platform through a second application, wherein a command of the first platform initiates the second application.

In one embodiment, wherein the first platform transmits the identifying information to the second server.

In one embodiment, the first server transmits the identifying information to the second server.

In one embodiment, the first platform transmits the identifying information to the second platform, and the second platform transmits the identifying information to the second server.

In one embodiment, the second platform is provided by a financial institution managing the transaction information of the plurality of stock brokerage firms, and the mobile device of the user accesses the second platform through a second web page, wherein a command of the first platform initiates the second webpage.

In one embodiment, the second platform further comprises providing an interface for displaying subjects and selective options of each subject associated with the first stock for voting.

In one embodiment, the second platform further comprises an interface to display a confirmation message to confirm a success of the voting.

In an embodiment, the method further comprises a module for generating a voting file based on the subjects and the selective options of each subject.

In one embodiment, the method further comprises providing an operation interface comprising at least one voting subject; selecting a first subject of the at least one voting subject; providing a voting interface for the first subject and multiple selective options of the first subject for the user to vote.

In one embodiment, the method further comprises providing an interface for entering passwords for logging into the second platform.

The present invention discloses a system of carrying out a shareholder voting by automatically crossing different platforms, said system comprising: a first server, wherein the first server communicates with a first platform of the mobile device of the user and obtains the authentication information of the user associated with a first brokerage account of a first brokerage firm to enable the user to perform stock transactions with the first brokerage firm; and a second server, wherein the second server is associated with a total number of a first stock of the user obtained from different sources; wherein the mobile device is connected to a second platform through a command on the first platform on mobile device, wherein the second server obtains identifying information of the authentication information of the user to identify the user and communicates with the second platform on the mobile device to enable the user to perform a first shareholder voting through the second platform based on the total number of the first stock of the user.

In one embodiment, the different sources includes all of the sources to obtain the first stock of the user, wherein the different sources comprise a plurality of brokerage accounts and an issuance company of the first stock.

In one embodiment, the second server is provided by a depository and clearing house, and the plurality of brokerage accounts are associated with the depository and clearing house.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 is a schematic view illustrating a system of carrying out a shareholder voting by automatically crossing different platforms;

FIG. 2 is a flow chart illustrating of a method for carrying out a shareholder voting by automatically crossing different platforms;

FIGS. 3A and 3B are schematic views of a mobile platform to carry out shareholder voting;

FIG. 4 is a schematic view illustrating the hardware architecture of the system of carrying out a shareholder voting by automatically crossing different platforms in accordance with one embodiment of the present invention; and

FIG. 5 is a schematic view illustrating the software architecture of the system of carrying out a shareholder voting by automatically crossing different platforms in accordance with one embodiment of the present invention.

### DETAILED DESCRIPTION OF THE INVENTION

The invention is described in detail below. The aforementioned preferred embodiments are for illustrative and descriptive purposes and are not intended to limit the scope of the invention.

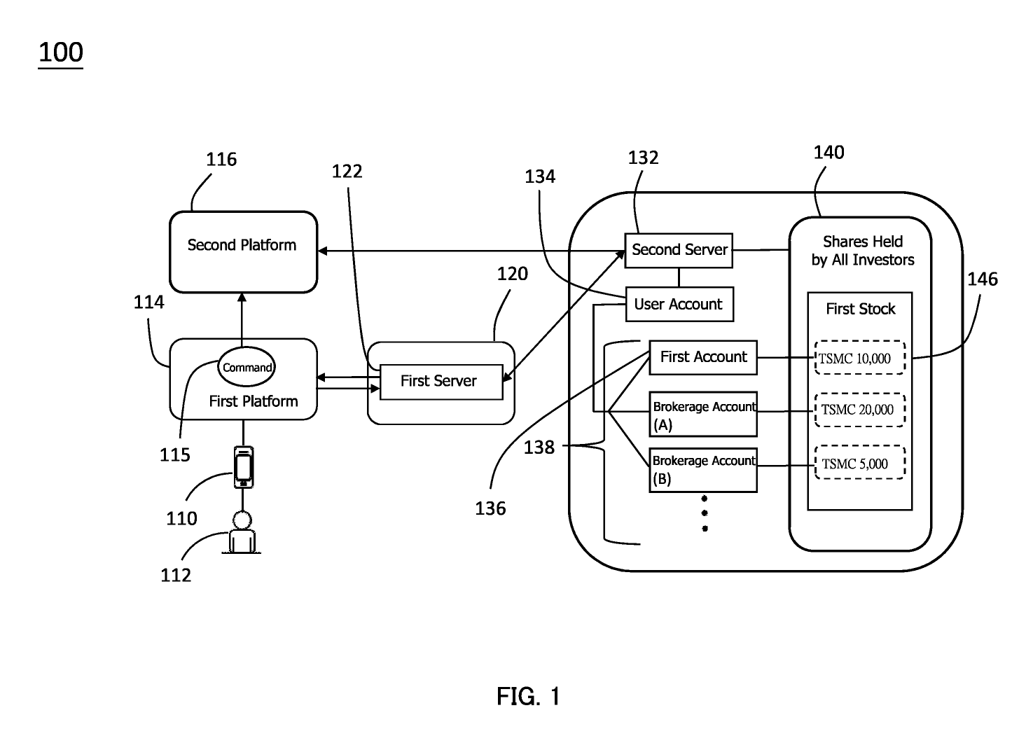

FIG. 1 illustrates a system of carrying out a shareholder voting by automatically crossing different platforms. As shown in FIG. 1, a system of carrying out a shareholder voting by automatically crossing different platforms comprises a first server 122 connected to a first platform 114 on a mobile device 110 of a user 112, wherein the first server 122 communicates with the first platform 114 of the mobile device 110 of the user 112 and obtains the authentication information of a first account 136 of a first stock brokerage firm 120 of the user 112 to enable the user perform stock transactions with the brokerage firm 120; and a second server 132 connected to the first server 122, wherein the second server 132 can be associated with a plurality of brokerage accounts 138 owned by the user 112, wherein the plurality of brokerage accounts 138 comprise the first account 136 of the first brokerage firm 120.

In one embodiment, the identifying information obtained from the authentication information includes an identity card number or a social security code.

In one embodiment, the different sources includes all of the sources to obtain the first stock 146 of the user, wherein the different sources comprise a plurality of brokerage accounts and an issuance company of the first stock. The user 112 may have at least two brokerage accounts, wherein the second server 132 enables the user 112 to carry out shareholder voting on the relevant subjects of the first stock 146 of the at least two brokerage accounts via the second platform 116, and the second server 132 does not need to perform another authentication procedure to verify the identity of user 112 for the brokerage accounts other than the first account 136. In one embodiment, please refer to FIG. 1, the first stock 146 is a TSMC (Taiwan Semiconductor Manufacturing Company) stock, wherein the TSMC shares owned by the user 112 comprise 10,000 shares in the first account 136 of the first brokerage firm, 120, 20,000 shares in the brokerage account (A) and 5,000 shares in the brokerage account (B). Thus, the total number of shares of the first stock 146 owned by the user from all of the sources is 10,000 shares+20,000 shares+5,000 shares=35,000 shares.

In one embodiment, the first platform 114 is provided by the first stock brokerage firm 120, and the mobile device 110 of the user 112 accesses the first platform 114 through a first application.

In one embodiment, the first platform 114 is provided by the first stock brokerage firm 120, and the mobile device 110 of the user 112 accesses the first platform 114 through a first webpage.

In one embodiment, the second platform 116 is provided by a financial institution that manages the transaction information of the stocks of the plurality of brokerage firms, the mobile device 110 of the user 112 accesses the second platform 116 through a second application, wherein a command of the first platform 114 initiates the second application.

In one embodiment, the second platform 116 is provided by a financial institution that manages the transaction information of the stocks of the plurality of brokerage firms, the mobile device 110 of the user 112 accesses the second platform 116 through a second application, wherein a command of the first platform 114 initiates the second webpage.

In one embodiment, the second platform 116 further comprises the step of providing an interface for displaying subjects associated with the first stock 146 and selective options of each subject for the user to choose.

In one embodiment, the second platform 116 further comprises an interface for displaying a voting confirmation message to notify the user that the voting is successfully carried out.

In one embodiment, the method further comprises a module for generating a voting file based on the subjects and selective options of each subject for the user to choose.

In one embodiment, the method further comprises providing an operation interface comprising at least one voting subject; selecting a first subject of the at least one voting subject; providing a voting interface for the first subject and multiple selective options of the first subject.

In one embodiment, the method further comprises providing an interface for a password for logging into the second platform 116.

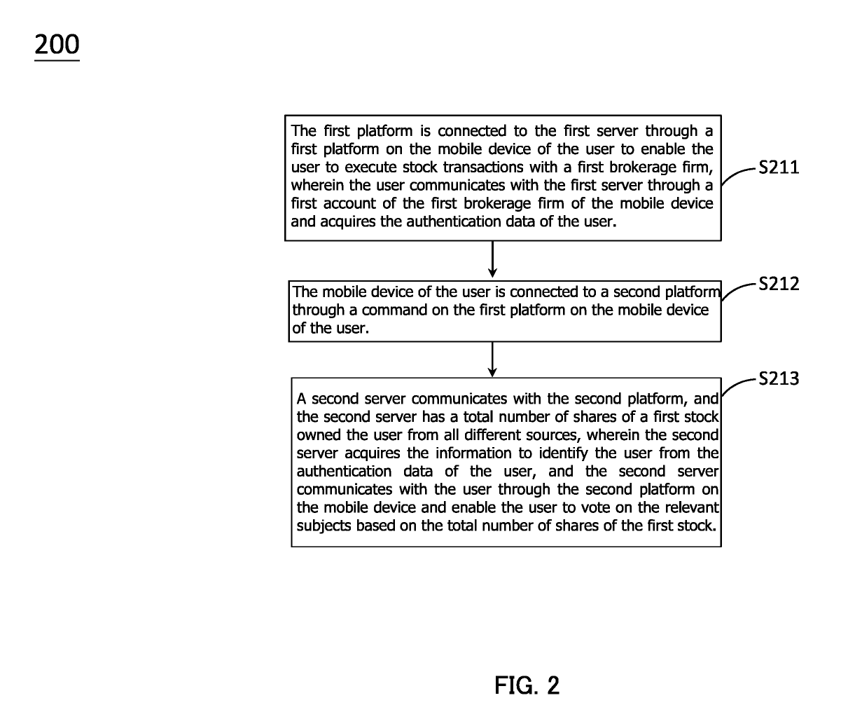

FIG. 2 illustrates a method for carrying out a shareholder voting by automatically crossing different platforms. Please refer to FIG. 1 and FIG. 2. The a method for carrying out a shareholder voting by automatically crossing different platforms comprises the following steps: in a step 211, the first platform is connected to the first server 122 through a first platform on the mobile device 110 of the user 112 to enable the user to perform stock transactions with a first brokerage firm 120, wherein the user 112 communicates with the first server 122 through the first account of the first brokerage firm 120 of the mobile device 110 and obtains the authentication information of the user 112; in a step 212, the mobile device 110 of the user 112 is connected to a second platform through a command on the first platform 114 on the mobile device 110 of the user 112; and in a step 213, a second server communicates with the user 112 through the second platform on the mobile device 110 to carry out shareholder voting, wherein the second server 132 has a total number of shares of a first stock 146 owned the user from all different sources, wherein the second server 132 obtains the identifying information from the authentication information of the user 112 through the first platform 114, wherein the second server enable the user to vote on the relevant subjects based on the total number of shares of a first stock 146 through the second platform 116.

In one embodiment, all of the different sources comprise a plurality of brokerage accounts and subscription shares issued by the first stock issuance company. The user 112 may have at least two brokerage accounts, wherein the second server 132 enables the user 112 to vote on all the relevant subjects of the first stock 146 of the at least two brokerage accounts through the second platform 116, and the second server 132 does not need to perform another authentication procedure with the user 112 for the shareholder voting.

In one embodiment, the first platform 114 is provided by the first brokerage firm 120, and the mobile device 110 of the user 112 accesses the first platform 114 through a first webpage.

In one embodiment, the first platform 114 is provided by the first brokerage firm 120, and the mobile device 110 of the user 112 accesses the first platform 114 through a first webpage.

In one embodiment, the second platform 116 is provided by a financial institution that manages the transaction information for the plurality of brokerage firms, and the mobile device 110 of the user 112 accesses the second platform 116 through a second application on the mobile device, wherein a command of the first platform 114 initiates the second application.

In one embodiment, the second platform 116 is provided by a financial institution that manages the transaction information for the plurality of brokerage firms, and the mobile device 110 of the user 112 accesses the second platform 116 through a second webpage, wherein a command of the first platform 114 initiates the second webpage.

In one embodiment, the first platform 114 transmits identifying information to the second server 132, wherein said identifying information is obtained from said authentication information of the user.

In one embodiment, the first server 122 transmits identifying information to the second server 132, wherein said identifying information is obtained according to authentication information of the user.

In the embodiment, the first platform 114 transmits the identifying information to the second platform 116, and the second platform 116 transmits the identifying information to the second server 132, wherein said identifying information is obtained according to authentication information of the user.

In one embodiment, the second platform 116 further comprises the step of providing an interface for displaying subjects associated with the first stock 146 and selective options of each subject for the user to choose.

In one embodiment, the second platform 116 further comprises displaying a voting confirmation interface to verify that the vote is successfully carried out.

In one embodiment, if an electronic vote and a paper vote are both present, then the electronic vote will not be counted.

In one embodiment, the method further comprises a module for generating a voting file based on the subjects and selective options of each subject for the user to choose.

In one embodiment, the method further comprises providing an operation interface comprising at least one voting subject; selecting a first subject of the at least one voting subject; providing a voting interface for the first subject and multiple selective options of the first subject.

In one embodiment, the method further comprises providing an interface for a password for logging into the second platform 116.

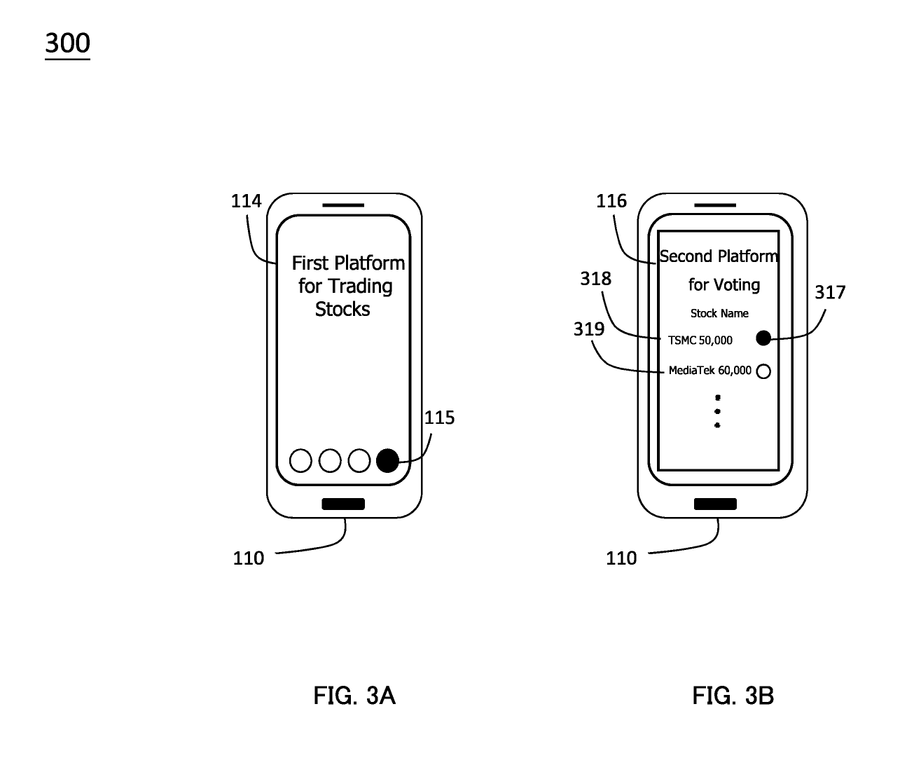

FIG. 3A is a schematic view of a mobile platform for carrying out shareholder voting. As shown in FIG. 3A, the first platform 114 displayed on the mobile device is a platform for the first brokerage firm 120 to buy and sell shares, and the user 112 may access the first platform 114 on the mobile device to trade stocks. The first platform 114 displays the command 115 as an icon 115. When the user presses the icon 115, the mobile platform displays the second platform 116 to carry out shareholder voting. As shown in FIG. 3B, the second platform 116 displays all the brokerage accounts of the user 112, the stock type and the number of shares of all the brokerage accounts of the user 112. The first platform 114 may also display the total number of a particular stock in all brokerage accounts of the user 112 for the user 112 to vote on subjects associated with the particular stock. If the second platform 116 indicates that the user 112 owns 50,000 shares TSMC stock 318 and 60,000 shares of MediaTek stock 319, wherein the user 112 can press the icon 317 to select TSMC shares to vote on the subjects associated with the TSMC stock. In one embodiment, the mobile device 110 of the user is the only device that can be used by the user 112 to communicate with the at least one server to trade stocks with a brokerage firm through the first platform 114 on the mobile device 110. After the user 112 is authenticated by the at least one server, the user can connect the mobile device 110 to the second platform 116 through a command 115 on the first platform 114 on the mobile device 110 to carry out shareholder voting.

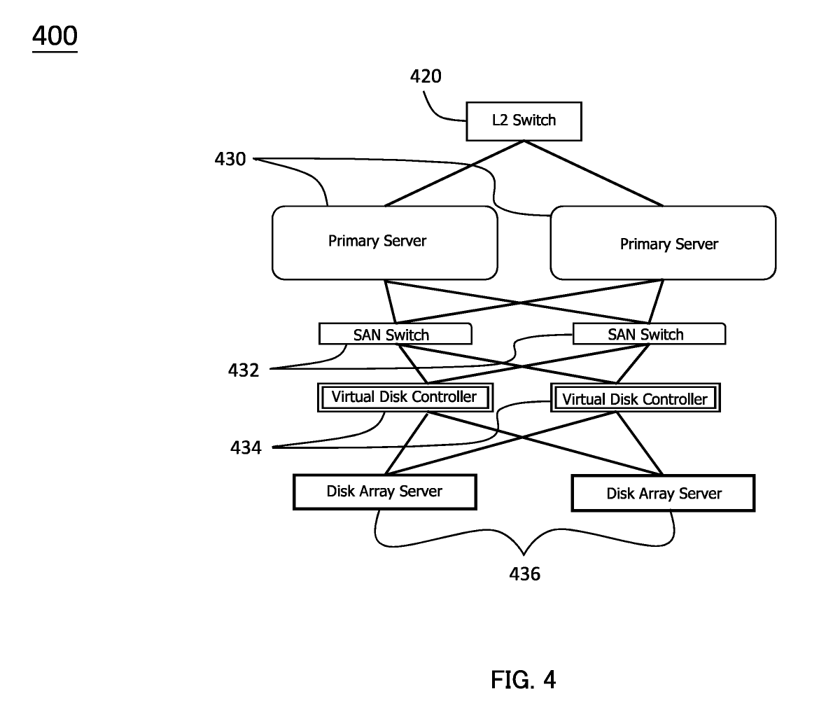

As shown in FIG. 4, the hardware structure of the shareholder voting system is divided into a L2 Switch 420 and a core switch. The L2 Switch 420 is connected to a primary server 430 and a firewall. The primary server 430 is connected to a SAN switch 432. The SAN switch 432 is connected to a disk array server 436 via a virtual disk controller 434. The core switch and the L2 Switch 420 are connected to a database through the firewall of a network. The primary server 430 uses a virtual disk controller 434 to bridges all demands from the internal and external network. The voting system can use the disk array server 436 to store data. Two or more disk array servers 436 can be used to make the voting system highly reliable.

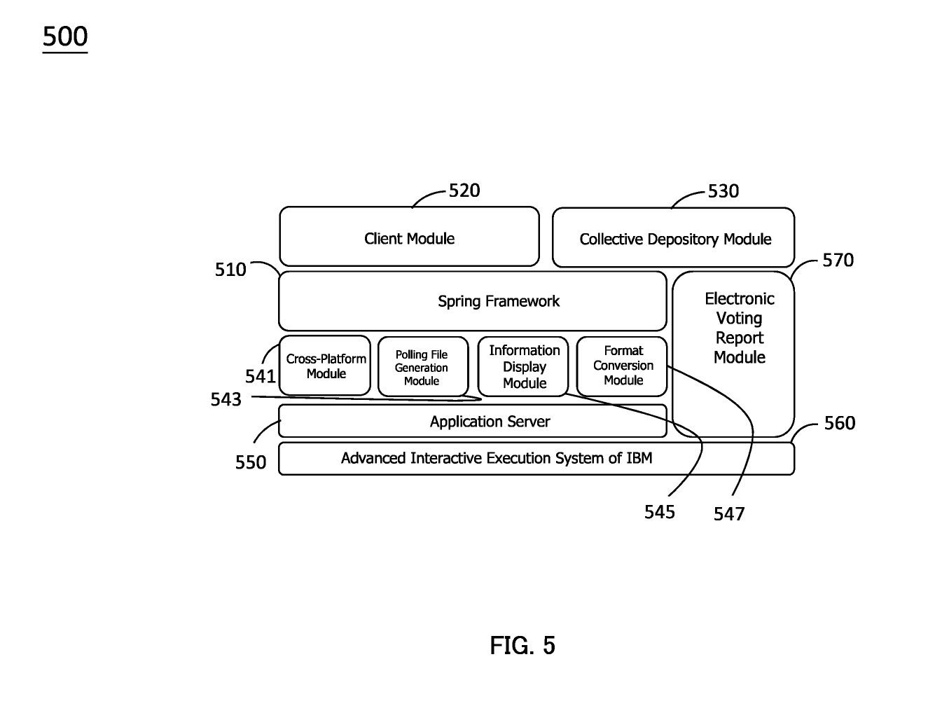

FIG. 5 is a schematic view illustrating the software architecture of a shareholder voting system in accordance with one embodiment of the present invention. As shown in FIG. 5, a client module 520 is disposed on a spring framework 510 to enable the user to vote, a collective depository module 530 to manage electronic voting, a cross-platform module 541 to connect the first platform 114 on the mobile device 110 to the second platform 116 to vote electronically, a polling file generation module 543 for generating a voting file based on the voting subjects, an information display module 545 to display relevant information about electronic voting, a format conversion module 547 to convert various electronic voting formats and an electronic voting report module 570 to print the results of electronic voting. The spring framework 510 is also provided with an application server 550 with an advanced interactive execution system 560 of International Business Machines Corporation (IBM) to make the system more versatile and efficient to support diversified applications.

The hardware and software architecture of the shareholder voting system of present invention can use load balancing architecture with multiple servers to achieve high availability. Through this mechanism, the traffic load can be distributed equally to each server to achieve load balancing. If one server is shut down in the group, the load balancing will direct the load of the failed server to other servers, thereby providing uninterrupted network services. The use of a server load balancing architecture provides the following benefits: increased reliability, improved server service performance, easier server management, and independence of hardware architecture or operating systems.

While the present invention has been described above with reference to the aforementioned preferred embodiments, it is not intended to limit the present invention. One person skilled in the art will appreciate a few alterations and modifications without departing from the spirit and scope of the invention. The scope of protection of the present invention is subject to the scope of the patent application as set forth in this specification.

What is claimed is:

1. A method to carry out a shareholder voting by automatically crossing different platforms, the method comprising:
using a first platform on a mobile device of a user to connect with a first server, wherein the first server communicates with the first platform on the mobile device and obtains the authentication information of the user associated with a first brokerage account of a first brokerage firm to enable the user to perform stock transactions with the first brokerage firm;
using a command of the first platform on the mobile device of the user to connect the mobile device to a second platform on the mobile device of the user; and
using a second server to communicate with the second platform on the mobile device, wherein the second server is associated with a total number of a first stock of the user obtained from different sources, wherein the second server obtains identifying information of the authentication information of the user to identify the user and communicates with the second platform on the mobile device to enable the user to perform a first shareholder voting based on the total number of the first stock of the user.

2. The method of claim 1, wherein the different sources includes all of the sources to obtain the first stock of the user, wherein the different sources comprise a plurality of brokerage accounts and an issuance company of the first stock.

3. The method of claim 2, wherein the second server is associated with a total number of a second stock of the user obtained from different sources to enable the user to perform a second shareholder voting through the second platform based on the total number of the second stock of the user.

4. The method of claim 1, wherein the first platform is provided by the first brokerage firm, wherein the mobile device of the user accesses the first platform through a first application, and wherein the first platform transmits said identifying information to the second server.

5. The method of claim 1, wherein the second platform is provided for a depository and clearing house associated with the first brokerage account, and the mobile device of the user accesses the second platform through a second application, wherein the first platform transmits said identifying information to the second platform, and the second platform transmits said identifying information to the second server.

6. The method of claim 1, wherein the second platform is provided by a financial institution that manages the transaction information for the plurality of brokerage firms, and the mobile device of the user accesses the second platform through a second application on the mobile device, wherein a command of the first platform initiates the second application.

7. The method of claim 1, wherein the second platform is provided by a financial institution that manages the transaction information for the plurality of brokerage firms, and the mobile device of the user accesses the second platform through a second webpage, wherein a command of the first platform initiates the second webpage.

8. The method of claim 1, wherein the first platform transmits the identifying information to the second server.

9. The method of claim 1, wherein the first server transmits the identifying information to the second server.

10. The method of claim 1, wherein the first platform transmits the identifying information to the second platform, and the second platform transmits the identifying information to the second server.

11. A system of carrying out a shareholder voting by automatically crossing different platforms, said system comprising:
a first server, wherein the first server communicates with a first platform of the mobile device of the user and obtains the authentication information of the user associated with a first brokerage account of a first brokerage firm to enable the user to perform stock transactions with the first brokerage firm; and
a second server, wherein the second server is associated with a total number of a first stock of the user obtained from different sources;
wherein the mobile device is connected to a second platform through a command on the first platform on mobile device, wherein the second server obtains identifying information of the authentication information of the user to identify the user and communicates with the second platform on the mobile device to enable the user to perform a first shareholder voting based on the total number of the first stock of the user.

12. The system of claim 11, wherein the different sources includes all of the sources to obtain the first stock of the user, wherein the different sources comprise a plurality of brokerage accounts and an issuance company of the first stock.

13. The system of claim 11, wherein the second server is associated with a total number of a second stock of the user obtained from different sources to enable the user to perform a second shareholder voting through the second platform based on the total number of the second stock of the user.

14. The system of claim 11, wherein the first platform is provided by the first brokerage firm, wherein the mobile device of the user accesses the first platform through a first application, and wherein the first platform transmits said identifying information to the second server.

15. The system of claim 11, wherein the second platform is provided for a depository and clearing house associated with the first brokerage account, and the mobile device of the user accesses the second platform through a second application, wherein the first platform transmits said identifying information to the second platform, and the second platform transmits said identifying information to the second server.

16. The system of claim 11, wherein the second platform is provided by a financial institution that manages the transaction information for the plurality of brokerage firms, and the mobile device of the user accesses the second platform through a second application on the mobile device, wherein a command of the first platform initiates the second application.

17. The system of claim 11, the second platform is provided by a financial institution that manages the transaction information for the plurality of brokerage firms, and the mobile device of the user accesses the second platform through a second webpage, wherein a command of the first platform initiates the second webpage.

18. The system of claim 11, wherein the first platform transmits the identifying information to the second server.

19. The system of claim 11, wherein the first server transmits the identifying information to the second server.

20. The system of claim 11, wherein the first platform transmits the identifying information to the second platform, and the second platform transmits the identifying information to the second server.
